(19) United States
(12) Patent Application Publication
(10) Pub. No.: US 2025/0168680 A1
(43) Pub. Date: May 22, 2025

(54) QUALITY OF EXPERIENCE REPORTING DURING A NETWORK OVERLOAD

(71) Applicant: QUALCOMM Incorporated, San Diego, CA (US)

(72) Inventors: Jianhua LIU, Beijing (CN); Shankar KRISHNAN, Poway, CA (US)

(21) Appl. No.: 18/838,379

(22) PCT Filed: Apr. 24, 2022
(86) PCT No.: PCT/CN2022/088760

§ 371 Date: Aug. 14, 2024

(51) Int. Cl. H04W 24/10; H04W 28/02

(52) U.S. Cl. CPC H04W 24/10; H04W 28/0284

(57) ABSTRACT

Various aspects of the present disclosure generally relate to wireless communication. In some aspects, a user equipment (UE) may determine, by a UE radio resource control (RRC) layer of the UE, that a quality of experience (QoE) reporting is paused based at least in part on a network overload, wherein buffered QoE data for a QoE configuration is stored at the UE when the QoE reporting is paused. The UE may receive, at the UE RRC layer from a UE application layer of the UE, an attention command that indicates a QoE measurement session stop indication for the QoE configuration. The UE may transmit, based at least in part on the attention command, the buffered QoE data without discarding the buffered QoE data stored at the UE. Numerous other aspects are described.

### FIELD OF THE DISCLOSURE

Aspects of the present disclosure generally relate to wireless communication and to techniques and apparatuses for quality of experience (QoE) reporting during a network overload.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: determine, by a UE radio resource control (RRC) layer of the UE, that a quality of experience (QoE) reporting is paused based at least in part on a network overload, wherein buffered QoE data for a QoE configuration is stored at the UE when the QoE reporting is paused; receive, at the UE RRC layer from a UE application layer of the UE, an attention command that indicates a QoE measurement session stop indication for the QoE configuration; and transmit, based at least in part on the attention command, the buffered QoE data without discarding the buffered QoE data stored at the UE.

In some implementations, a method of wireless communication performed by a UE includes determining, by a UE RRC layer of the UE, that a QoE reporting is paused based at least in part on a network overload, wherein buffered QoE data for a QoE configuration is stored at the UE when the QoE reporting is paused; receiving, at the UE RRC layer from a UE application layer of the UE, an attention command that indicates a QoE measurement session stop indication for the QoE configuration; and transmitting, based at least in part on the attention command, the buffered QoE data without discarding the buffered QoE data stored at the UE.

In some implementations, a non-transitory computer-readable medium storing a set of instructions for wireless communication includes one or more instructions that, when executed by one or more processors of a UE, cause the UE to: determine, by a UE RRC layer of the UE, that a QoE reporting is paused based at least in part on a network overload, wherein buffered QoE data for a QoE configuration is stored at the UE when the QoE reporting is paused; receive, at the UE RRC layer from a UE application layer of the UE, an attention command that indicates a QoE measurement session stop indication for the QoE configuration; and transmit, based at least in part on the attention command, the buffered QoE data without discarding the buffered QoE data stored at the UE.

In some implementations, an apparatus for wireless communication includes means for determining, by an apparatus RRC layer of the apparatus, that a QoE reporting is paused based at least in part on a network overload, wherein buffered QoE data for a QoE configuration is stored at the apparatus when the QoE reporting is paused; means for receiving, at the apparatus RRC layer from an apparatus application layer of the apparatus, an attention command that indicates a QoE measurement session stop indication for the QoE configuration; and means for transmitting, based at least in part on the attention command, the buffered QoE data without discarding the buffered QoE data stored at the apparatus.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a disaggregated base station architecture, in accordance with the present disclosure.

FIGS. 4-5 are diagrams illustrating examples of quality of experience (QoE) reporting, in accordance with the present disclosure.

FIGS. 6-8 are diagrams illustrating examples associated with QoE reporting during a network overload, in accordance with the present disclosure.

FIG. 9 is a diagram illustrating an example process associated with QoE reporting during a network overload, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

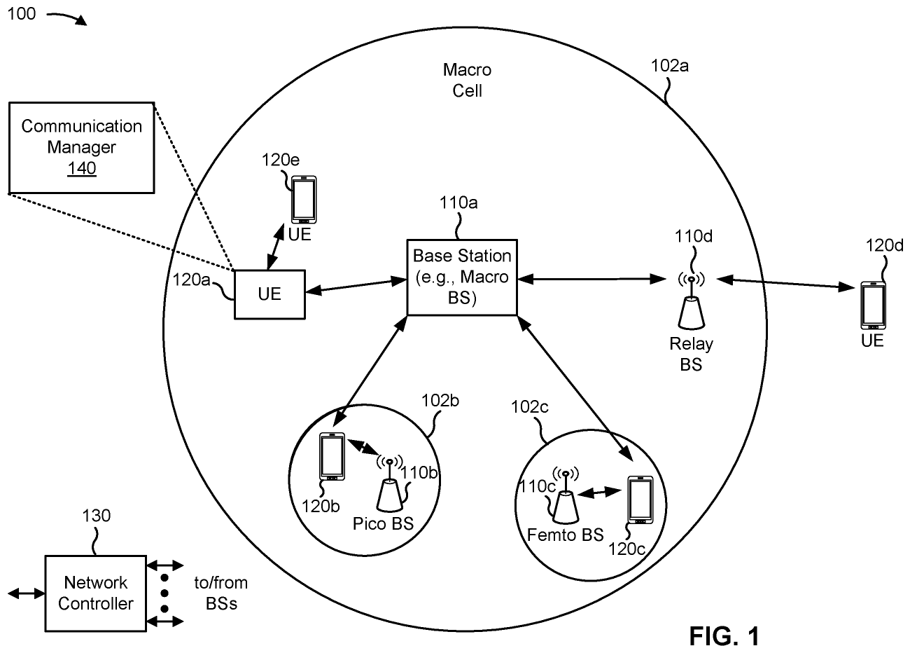

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FRI is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may determine, by a UE radio resource control (RRC) layer of the UE, that a quality of experience (QoE) reporting is paused based at least in part on a network overload, wherein buffered QoE data for a QoE configuration is stored at the UE when the QoE reporting is paused; receive, at the UE RRC layer from a UE application layer of the UE, an attention command that indicates a QoE measurement session stop indication for the QoE configuration; and transmit, based at least in part on the attention command, the buffered QoE data without discarding the buffered QoE data stored at the UE. Additionally, or alternatively, the communication manager 140 may perform one or more other operations described herein.

As indicated above, FIG. 1 is provided as an example. Other examples may differ from what is described with regard to FIG. 1.

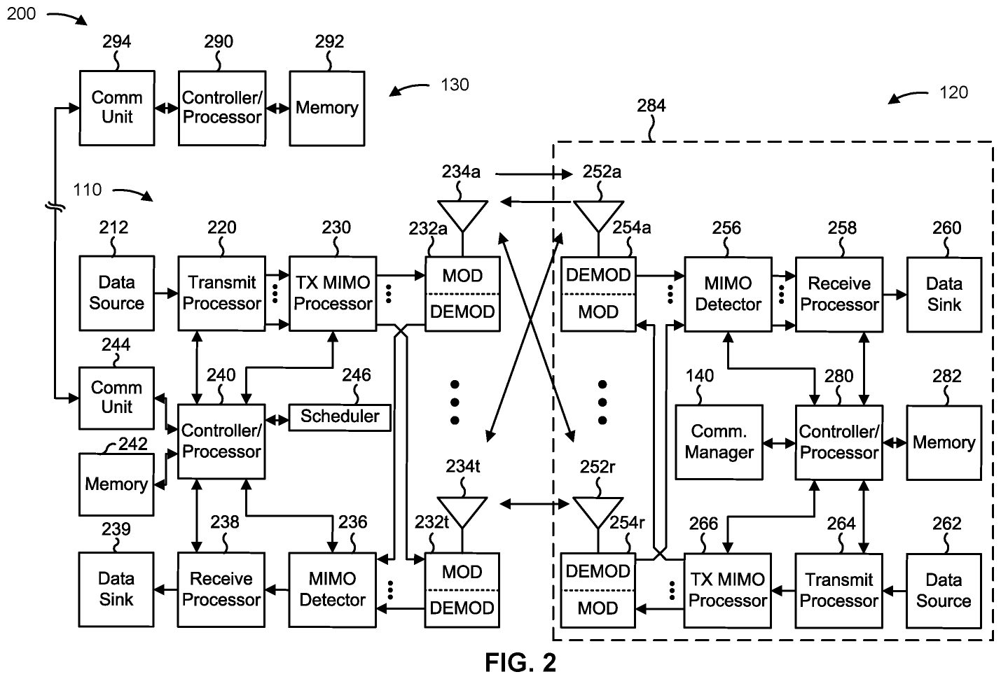

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

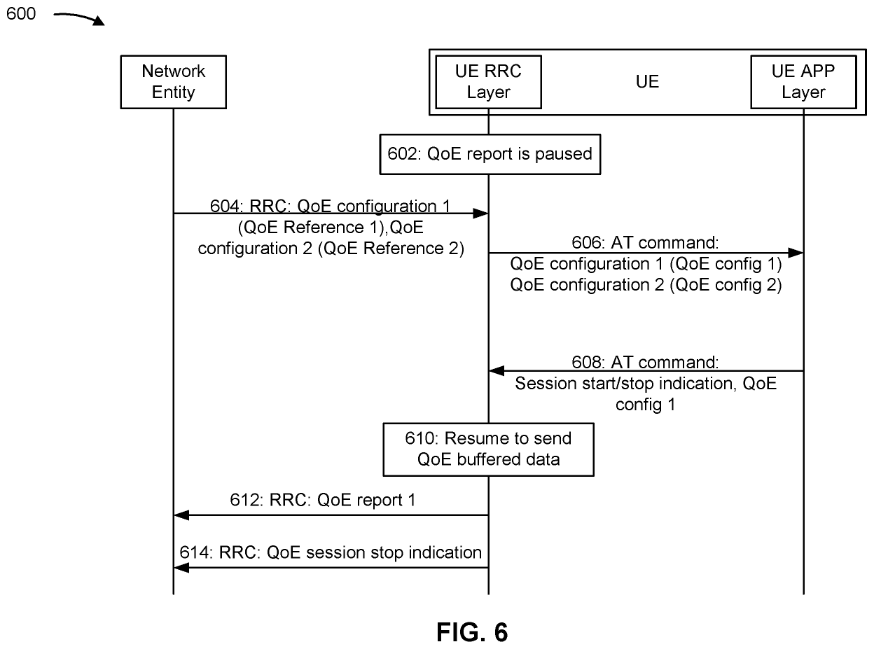

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-10).

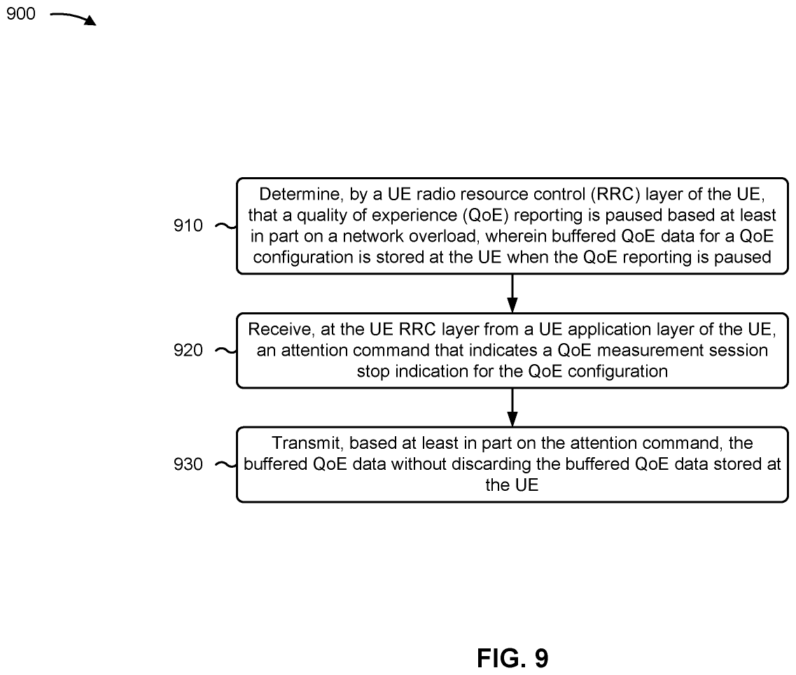

The controller/processor 240 of the base station 110, the controller/processor 280 of the UE 120, and/or any other component(s) of FIG. 2 may perform one or more techniques associated with QoE reporting during a network overload, as described in more detail elsewhere herein. For example, the controller/processor 240 of the base station 110, the controller/processor 280 of the UE 120, and/or any other component(s) of FIG. 2 may perform or direct operations of, for example, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, and/or other processes as described herein. In some examples, executing instructions may include running the instructions, converting the instructions, compiling the instructions, and/or interpreting the instructions, among other examples.

In some aspects, a UE (e.g., UE 120) includes means for determining, by a UE radio resource control (RRC) layer of the UE, that a quality of experience (QoE) reporting is paused based at least in part on a network overload, wherein buffered QoE data for a QoE configuration is stored at the UE when the QoE reporting is paused; means for receiving, at the UE RRC layer from a UE application layer of the UE, an attention command that indicates a QoE measurement session stop indication for the QoE configuration; and/or means for transmitting, based at least in part on the attention command, the buffered QoE data without discarding the buffered QoE data stored at the UE. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

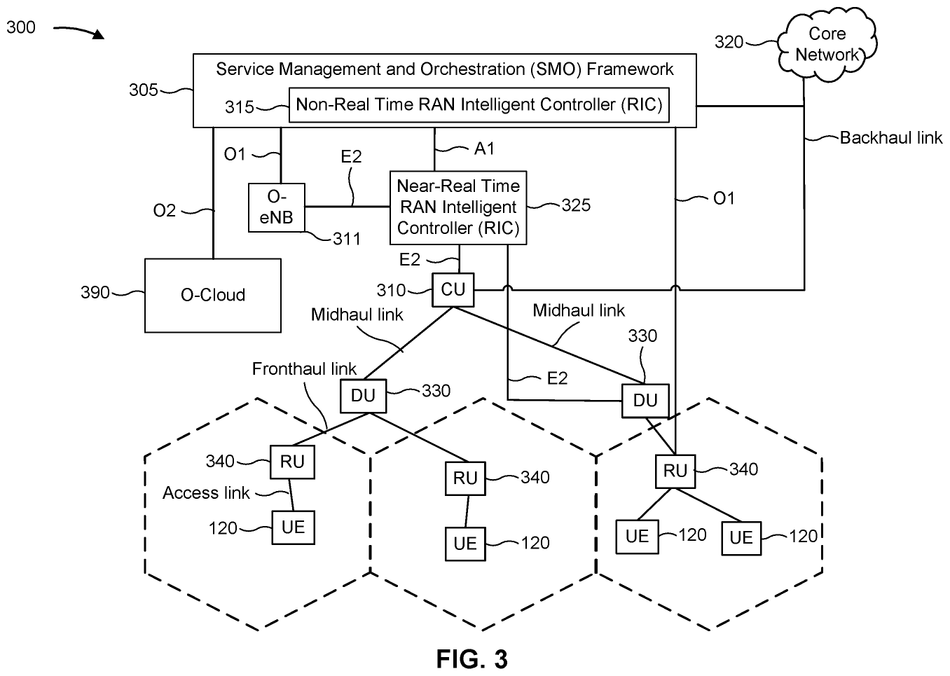

FIG. 3 is a diagram illustrating an example 300 of a disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an IAB network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

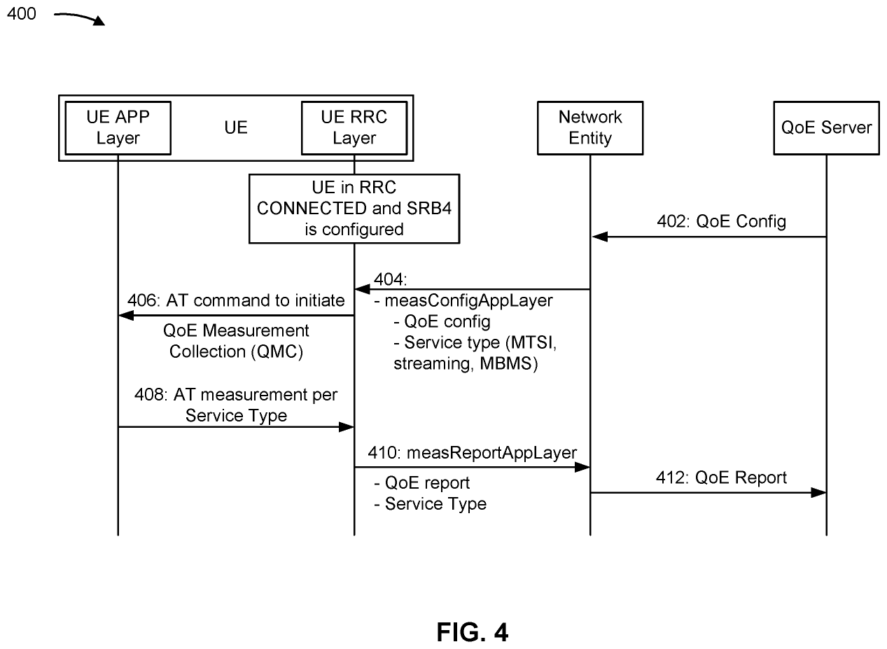

FIG. 4 is a diagram illustrating an example 400 of QoE reporting, in accordance with the present disclosure. As shown in FIG. 4, example 400 includes communication between a UE (e.g., UE 120), a network entity (e.g., base station 110), and a QoE server. In some aspects, the UE, the network entity, and the QoE server may be included in a wireless network, such as wireless network 100.

The UE may be configured with a QoE configuration (e.g., a QoE measurement configuration) using an RRC reconfiguration, which may indicate a measurement configuration application layer (measConfigAppLayer) message. The UE may transmit a QoE report indicating QoE measurements using a measurement report application layer (measReportAppLayer) message. The QoE report may be transmitted via a signaling radio bearer 4 (SRB4).

As shown by reference number 402, the QoE server may transmit the QoE configuration to the network entity. As shown by reference number 404, the network entity may transmit, to a UE RRC layer of the UE, the RRC reconfiguration. The RRC reconfiguration may indicate the measConfigAppLayer message, which may indicate the QoE configuration and a service type. The service type may be multimedia telephony service for internet protocol (IP) multimedia subsystem (IMS) (MTSI), streaming, or multicast broadcast multicast service (MBMS). The UE RRC layer may receive the RRC reconfiguration when the UE is in an RRC connected state and the SRB4 is configured. As shown by reference number 406, the UE RRC layer may transmit, to a UE application layer of the UE, an attention (AT) command to initiate a QoE measurement collection (QMC). The UE application may perform the QMC based at least in part on the attention command. As shown by reference number 408, the UE application layer may transmit, to the UE RRC layer, QoE measurements per service type, where the QoE measurements may be based at least in part on the QMC. As shown by reference number 410, the UE RRC layer may transmit, to the network entity, the measReportAppLayer message via RRC signaling. The measReportAppLayer message may indicate the QoE report and the service type, where the QoE report may indicate the QoE measurements associated with the service type. As shown by reference number 412, the network entity may transmit the QoE report to the QoE server.

As indicated above, FIG. 4 is provided as an example. Other examples may differ from what is described with regard to FIG. 4.

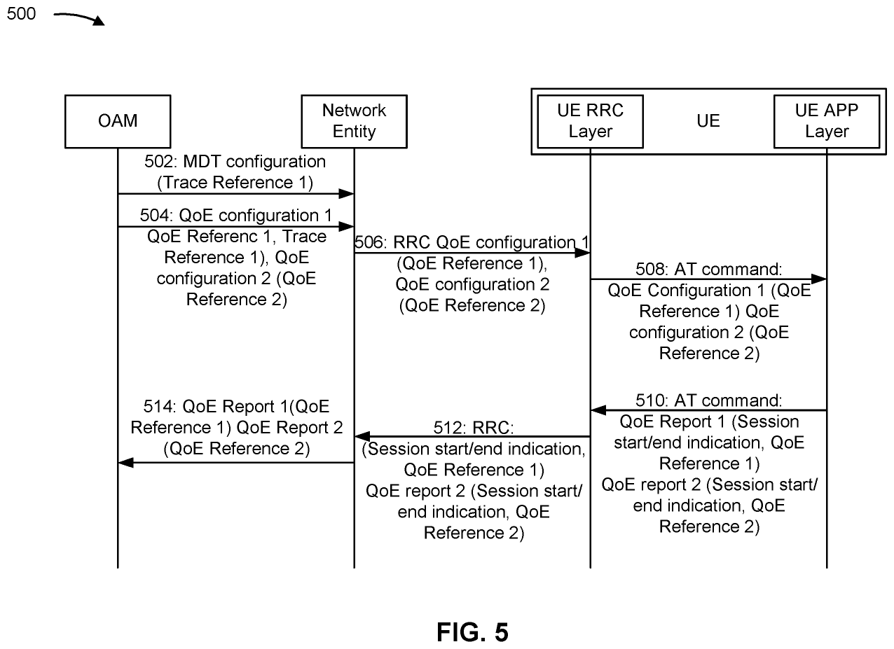

FIG. 5 is a diagram illustrating an example 500 of QoE reporting, in accordance with the present disclosure. As shown in FIG. 5, example 500 includes communication between a UE (e.g., UE 120), a network entity (e.g., a Next Generation radio access network (NG-RAN), which may include base station 110), and an operations, administration, and maintenance (OAM) server. In some aspects, the UE, the network entity, and the OAM server may be included in a wireless network, such as wireless network 100.

The UE may indicate, to the network entity via a flag, a QoE measurement session start/end indication. The UE may transmit the QoE measurement session start/end indication via an SRB4. The network entity may configure the UE with an associated minimization of driving test (MDT) configuration after receiving the QoE measurement session start indication from the UE. The network entity may deactivate the associated MDT configuration after receiving the QoE measurement session end indication from the UE. The QoE measurement session end indication may be referred to as a QoE measurement session stop indication. When the network entity receives a QoE stop indication for a QoE configuration, when the UE moves outside of a certain aera, the network entity may release the QoE configuration. Otherwise, the network entity may not release the QoE configuration.

As shown by reference number 502, the OAM may transmit, to the network entity, an MDT configuration, which may indicate a first trace reference. As shown by reference number 504, the OAM may transmit, to the network entity, a first QoE configuration and a second QoE configuration, where the first QoE configuration may be for a first QoE reference and the first trace reference, and the second QoE configuration may be for a second QoE reference. As shown by reference number 506, the network entity may transmit, to a UE RRC layer of the UE, the first QoE configuration and the second QoE configuration, where the first QoE configuration may be for the first QoE reference and the second QoE configuration may be for the second QoE reference. As shown by reference number 508, the UE RRC layer may transmit, to a UE application layer of the UE, an attention command that indicates the first QoE configuration and the second QoE configuration, where the first QoE configuration may be for the first QoE reference and the second QoE configuration may be for the second QoE reference.

As shown by reference number 510, the UE application layer may transmit, to the UE RRC layer, an attention command that indicates a first QoE report and a second QoE report. The first QoE report may indicate a session start/end indication for the first QoE reference. The second QoE report may indicate a session start/end indication for the second QoE reference. As shown by reference number 512, the UE RRC layer may transmit, to the network entity, an RRC message that indicates the first QoE report and the second QoE report. The first QoE report may indicate the session start/end indication for the first QoE reference. The second QoE report may indicate the session start/end indication for the second QoE reference. As shown by reference number 514, the network entity may transmit, to the OAM, the first QoE report indicating the first QoE reference and the second QoE report indicating the second QoE reference.

As indicated above, FIG. 5 is provided as an example. Other examples may differ from what is described with regard to FIG. 5.

A QoE report may be paused due to a RAN overload. For example, when traffic at a network entity (e.g., an NG-RAN, which may include a base station) satisfies a threshold, the QoE report may be paused. During the pause, QoE data may be buffered at a UE, and the QoE report may not be immediately transmitted to the network entity. When the network entity resumes QoE reporting (e.g., after the traffic does not satisfy the threshold), the UE may transmit buffered QoE data to the network entity.

When the QoE report is paused due to the RAN overload, the UE may buffer the QoE data. During the pause, when a UE RRC layer of the UE receives a QoE measurement session stop indication from a UE application layer of the UE for a QoE configuration, the UE RRC layer may transmit the QoE measurement session stop indication to the network entity. When the network entity receives the QoE measurement session stop indication from the UE RRC layer, and when the UE moves outside of a certain area (e.g., moves outside of an area scope), the network entity may release the associated QoE configuration. The UE may receive, from the network entity, a release command for the QoE configuration, which may be based at least in part on the network entity releasing the QoE configuration. When the UE RRC layer receives the release command for the QoE configuration, the UE may discard buffered QoE data, which may cause the buffered QoE data to be lost and not later transmitted to the network entity after the RAN overload has ended.

In various aspects of techniques and apparatuses described herein, a UE may determine, by a UE RRC layer of the UE, that a QoE reporting may be paused based at least in part on a network overload. Buffered QoE data for a QoE configuration may be stored at the UE when the QoE reporting is paused. The UE may receive, at the UE RRC layer from a UE application layer of the UE, an attention command that indicates a QoE measurement session stop indication for the QoE configuration. The UE may transmit, from the UE RRC layer to a network entity and based at least in part on the attention command, the buffered QoE data without discarding the buffered QoE data stored at the UE.

In some aspects, the UE RRC layer may resume sending buffered QoE data after the UE RRC layer receives the QoE measurement session stop indication from the UE application layer for the QoE configuration. In some aspects, the UE RRC layer may transmit, to the network entity, the QoE measurement session stop indication, which may include a buffered QoE data indication. The buffered QoE data indication may indicate that buffered QoE data is stored at the UE. The network entity may resume QoE reporting before releasing the QoE configuration, based at least in part on the buffered QoE data indication. In some aspects, the UE RRC layer may pause transmitting the QoE measurement session stop indication to the network entity when QoE reporting is paused. In some aspects, the UE RRC layer may transmit buffered QoE data after receiving a release command from the network entity, where the release command may release the QoE configuration. As a result, the buffered QoE data may not be discarded at the UE and may be transmitted to the network entity.

FIG. 6 is a diagram illustrating an example 600 associated with QoE reporting during a network overload, in accordance with the present disclosure. As shown in FIG. 6, example 600 includes communication between a UE (e.g., UE 120) and a network entity (e.g., an NG-RAN, which may include base station 110). In some aspects, the UE and the network entity may be included in a wireless network, such as wireless network 100.

As shown by reference number 602, a UE RRC layer of the UE may determine that QoE reporting is paused (e.g., due to a RAN overload), during which buffered QoE data may be stored at the UE. For example, the UE may store buffered QoE data associated with a QoE configuration (e.g., a first QoE configuration). As shown by reference number 604, the network entity may transmit, to the UE RRC layer, an RRC message that indicates the first QoE configuration and a second QoE configuration, where the first QoE configuration may be for a first QoE reference and the second QoE configuration may be for a second QoE reference. As shown by reference number 606, the UE RRC layer may transmit, to a UE application layer of the UE, an attention command that indicates the first QoE configuration and the second QoE configuration.

As shown by reference number 608, the UE application layer may transmit, to the UE RRC layer, an attention command that indicates a QoE measurement session stop indication for the first QoE configuration. The UE RRC layer may receive the attention command that indicates the QoE measurement session stop indication for the first QoE configuration. As shown by reference number 610, the UE RRC layer may resume to send buffered QoE data based at least in part on the QoE measurement session stop indication. As shown by reference number 612, the UE RRC layer may transmit an RRC message to the network entity, where the RRC message may indicate a first QoE report. The first QoE report may correspond to the first QoE configuration, and the first QoE report may indicate the buffered QoE data. As shown by reference number 614, the UE RRC layer may transmit, to the network entity, an RRC message that indicates a QoE measurement session stop indication. The UE RRC layer may transmit the RRC message with the QoE measurement session stop indication when the buffered QoE data (e.g., all of the buffered QoE data) is successfully transmitted to the network entity. The UE RRC layer may transmit the QoE measurement session stop indication together with a last QoE report. In some aspects, the UE RRC layer may resume transmitting the buffered QoE data based at least in part on a receipt of the QoE measurement session stop indication from the UE application layer for one QoE configuration (e.g., the first QoE configuration).

In some aspects, the UE may receive, at the UE RRC layer from the UE application layer of the UE, the attention command that indicates the QoE measurement session stop indication for the QoE configuration. The UE may transmit, from the UE RRC layer to the network entity and based at least in part on the attention command, the buffered QoE data without discarding the buffered QoE data stored at the UE. In some aspects, the UE may determine, by the UE RRC layer, to resume transmitting the buffered QoE data based at least in part on the attention command that indicates the QoE measurement session stop indication for the QoE configuration. The UE may transmit, from the UE RRC layer to the network entity, a first RRC message that includes a QoE report with the buffered QoE data. The UE may transmit, from the UE RRC layer to the network entity, a second RRC message that includes a QoE measurement session stop indication for indicating that the buffered QoE data has been successfully transmitted to the network entity. The second RRC message that includes the QoE measurement session stop indication may be optional because the fist RRC message that includes the QoE report with the buffered QoE data may imply the QoE measurement session stop indication. In some cases, the QoE measurement session stop indication may be sent together with the QoE report with the buffered QoE data.

As indicated above, FIG. 6 is provided as an example. Other examples may differ from what is described with regard to FIG. 6.

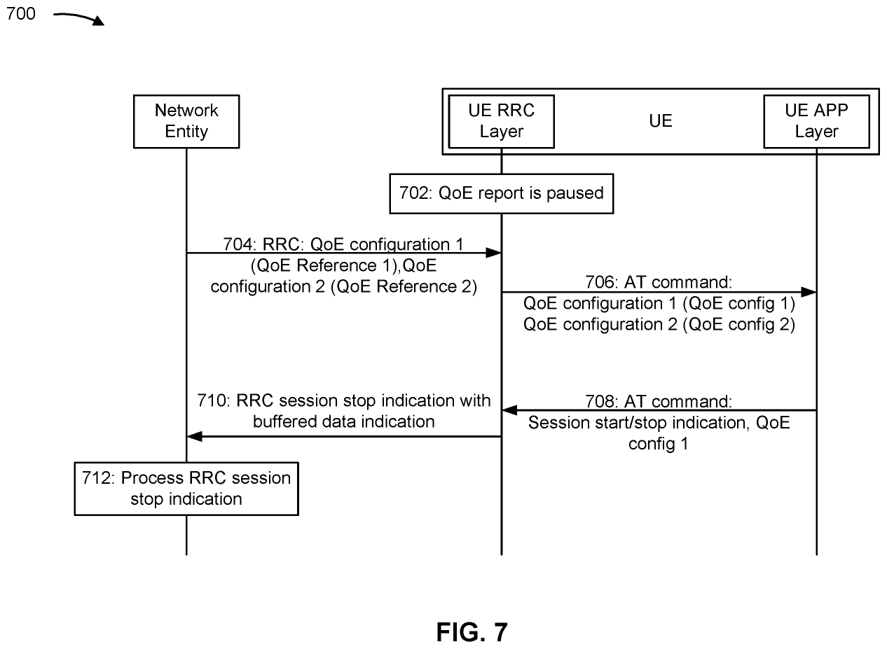

FIG. 7 is a diagram illustrating an example 700 associated with QoE reporting during a network overload, in accordance with the present disclosure. As shown in FIG. 7, example 700 includes communication between a UE (e.g., UE 120) and a network entity (e.g., an NG-RAN, which may include base station 110). In some aspects, the UE and the network entity may be included in a wireless network, such as wireless network 100.

As shown by reference number 702, a UE RRC layer of the UE may determine that QoE reporting is paused (e.g., due to a RAN overload), during which buffered QoE data may be stored at the UE. For example, the UE may store buffered QoE data associated with a QoE configuration (e.g., a first QoE configuration). As shown by reference number 704, the network entity may transmit, to the UE RRC layer, an RRC message that indicates the first QoE configuration and a second QoE configuration, where the first QoE configuration may be for a first QoE reference and the second QoE configuration may be for a second QoE reference. As shown by reference number 706, the UE RRC layer may transmit, to a UE application layer of the UE, an attention command that indicates the first QoE configuration and the second QoE configuration.

As shown by reference number 708, the UE application layer may transmit, to the UE RRC layer, an attention command that indicates a QoE measurement session stop indication for the first QoE configuration. The UE RRC layer may receive the attention command that indicates the QoE measurement session stop indication for the first QoE configuration. As shown by reference number 710, the UE RRC layer may transmit, to the network entity, an RRC message. The RRC message may indicate a QoE measurement session stop indication with a buffered QoE data indication. The QoE measurement session stop indication may be for the first QoE configuration, and may indicate whether buffered QoE data is available for the first QoE configuration.

As shown by reference number 712, the network entity may process the RRC message received from the UE RRC layer. When the RRC message includes the QoE measurement session stop indication with the buffered QoE data indication, the network entity may transmit a resume command to the UE RRC layer, and the UE RRC layer may resume transmitting the buffered QoE data to the network entity. When the RRC message includes the QoE measurement session stop indication with no buffered QoE data indication, the network entity may release the first QoE configuration in case the UE moves outside of a certain area (e.g., outside of an area scope). In some aspects, the UE RRC layer may transmit the QoE measurement session stop indication with the buffered QoE data indication, which may cause the network entity to operate accordingly.

In some aspects, the UE may receive, at the UE RRC layer from the UE application layer of the UE, the attention command that indicates the QoE measurement session stop indication for the QoE configuration. The UE may transmit, from the UE RRC layer to the network entity and based at least in part on the attention command, the buffered QoE data without discarding the buffered QoE data stored at the UE. In some aspects, the UE may transmit, from the UE RRC layer to the network entity and based at least in part on the attention command that indicates the QoE measurement session stop indication for the QoE configuration, a first RRC message that indicates the QoE measurement session stop indication for the QoE configuration and/or a buffered QoE data indication that indicates whether the buffered QoE data is available for the QoE configuration. The UE may receive, at the UE RRC layer from the network entity and based at least in part on the first RRC message that indicates the QoE measurement session stop indication for the QoE configuration and no buffered QoE data indication, a second RRC message that includes a release command to release the QoE configuration. Alternatively, the UE may receive, at the UE RRC layer from the network entity and based at least in part on the first RRC message that indicates the QoE measurement session stop indication for the QoE configuration and the buffered QoE data indication, a second RRC message that indicates a resume command, where transmitting the buffered QoE data from the UE RRC layer to the network entity may be resumed based at least in part on the resume command.

In some aspects, the UE RRC layer may pause transmitting the QoE measurement session stop indication to the network entity when QoE reporting is paused (e.g., due to a RAN overload). When the QoE reporting is resumed (e.g., due to the RAN no longer being overloaded), the UE RRC layer may resume transmitting the QoE measurement session stop indication to the network entity. The UE may be configured by the network entity whether to pause transmitting the QoE measurement session stop indication when the QoE reporting is paused. When QoE reporting is paused, if the UE RRC layer receives multiple QoE measurement session start/stop indications (e.g., multiple QoE session status indications) from the UE application layer, the UE RRC layer may overwrite a previously received QoE measurement session start/stop indication with a latest received QoE measurement session start/stop indication, and when the QoE reporting is resumed, the UE RRC layer may transmit the latest received QoE measurement session start/stop indication to the network entity.

In some aspects, the UE may determine, by the UE RRC layer, to pause transmitting an RRC message that includes the QoE measurement session stop indication for the QoE configuration based at least in part on the QoE reporting being paused. The UE may transmit, from the UE RRC layer to the network entity, the RRC message that includes the QoE measurement session stop indication for the QoE configuration based at least in part on the QoE reporting being resumed. In some aspects, the UE may receive, at the UE RRC layer from the network entity, a configuration that configures the UE RRC layer to pause transmitting the RRC message that includes the QoE measurement session stop indication for the QoE configuration based at least in part on the QoE reporting being paused. In some aspects, the UE may receive, at the UE RRC layer from the UE application layer, multiple QoE measurement session indications for the QoE configuration during the pause for transmitting the RRC message. The UE may overwrite, by the UE RRC layer, a previously received QoE measurement session indication of the multiple QoE measurement session indications with a newly received QoE measurement session indication of the multiple QoE measurement session indications.

As indicated above, FIG. 7 is provided as an example. Other examples may differ from what is described with regard to FIG. 7.

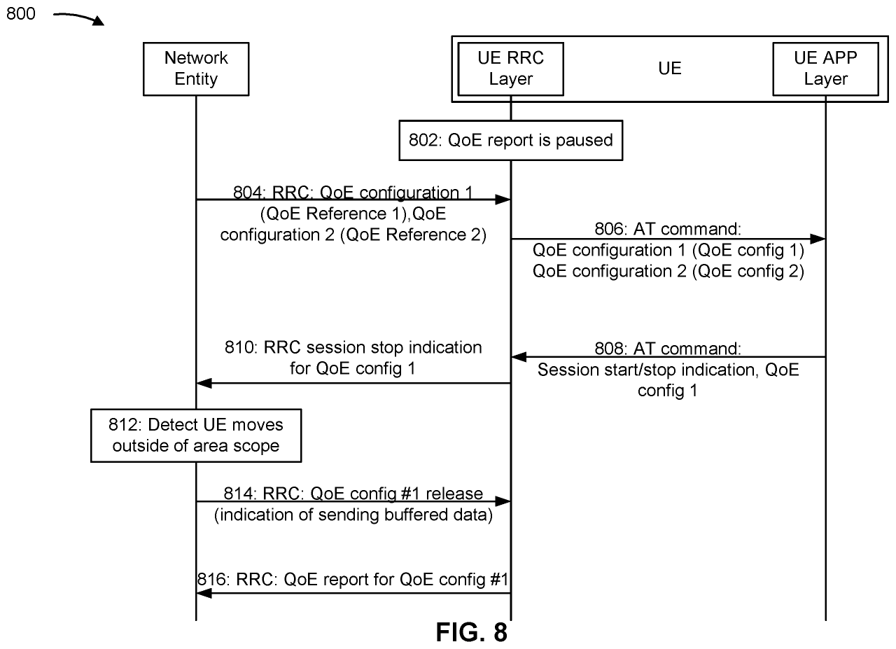

FIG. 8 is a diagram illustrating an example 800 associated with QoE reporting during a network overload, in accordance with the present disclosure. As shown in FIG. 8, example 800 includes communication between a UE (e.g., UE 120) and a network entity (e.g., an NG-RAN, which may include base station 110). In some aspects, the UE and the network entity may be included in a wireless network, such as wireless network 100.

As shown by reference number 802, a UE RRC layer of the UE may determine that QoE reporting is paused (e.g., due to a RAN overload), during which buffered QoE data may be stored at the UE. For example, the UE may store buffered QoE data associated with a QoE configuration (e.g., a first QoE configuration). As shown by reference number 804, the network entity may transmit, to the UE RRC layer, an RRC message that indicates the first QoE configuration and a second QoE configuration, where the first QoE configuration may be for a first QoE reference and the second QoE configuration may be for a second QoE reference. As shown by reference number 806, the UE RRC layer may transmit, to a UE application layer of the UE, an attention command that indicates the first QoE configuration and the second QoE configuration.

As shown by reference number 808, the UE application layer may transmit, to the UE RRC layer, an attention command that indicates a QoE measurement session stop indication for the first QoE configuration. The UE RRC layer may receive the attention command that indicates the QoE measurement session stop indication for the first QoE configuration. As shown by reference number 810, the UE RRC layer may transmit, to the network entity, an RRC message. The RRC message may indicate a QoE measurement session stop indication for the first QoE configuration.

As shown by reference number 812, the network entity may detect that the UE has moved outside of a certain area (e.g., moved outside of an area scope). In this case, the network entity may release the first QoE configuration. As shown by reference number 814, the network entity may transmit, to the UE RRC layer, an RRC message that indicates a release command for releasing the first QoE configuration. In other words, the network entity may indicate that the first QoE configuration should be released based at least in part on the UE moving outside of the certain area. The RRC message may also indicate whether the UE RRC layer should transmit buffered QoE data for the first QoE configuration. As shown by reference number 816, the UE RRC layer may transmit, to the network entity, buffered QoE data for the first QoE configuration, which may be based at least in part on the UE RRC layer receiving the RRC message from the network entity. In other words, the UE RRC layer may transmit the buffered QoE data after receiving the release command from the network entity. After the UE RRC layer transmits the buffered QoE data (e.g., all of the buffered QoE data) for the first QoE configuration, the UE RRC layer may indicate to the network entity that no more QoE data is buffered at the UE, and the UE and the network entity may release the first QoE configuration.

In some aspects, the UE may receive, at the UE RRC layer from the UE application layer of the UE, the attention command that indicates the QoE measurement session stop indication for the QoE configuration. The UE may transmit, from the UE RRC layer to the network entity and based at least in part on the attention command, the buffered QoE data without discarding the buffered QoE data stored at the UE. In some aspects, the UE may transmit, from the UE RRC layer to the network entity and based at least in part on the attention command that indicates the QoE measurement session stop indication for the QoE configuration, a first RRC message that indicates the QoE measurement session stop indication for the QoE configuration. In some aspects, the UE may receive, at the UE RRC layer from the network entity, a first RRC message that includes a release command to release the QoE configuration based at least in part on the UE moving outside of a certain area, where the first RRC message may include an indication to transmit the buffered QoE data for the QoE configuration. The UE may transmit, from the UE RRC layer to the network entity and based at least in part on the first RRC message, a second RRC message that includes a QoE report with the buffered QoE data for the QoE configuration. In some aspects, the UE may transmit, from the UE RRC layer to the network entity, an indication that all buffered QoE data for the QoE configuration has been transmitted to the network entity, where the UE and the network entity may release the QoE configuration based at least in part on the indication.

As indicated above, FIG. 8 is provided as an example. Other examples may differ from what is described with regard to FIG. 8.

FIG. 9 is a diagram illustrating an example process 900 performed, for example, by a UE, in accordance with the present disclosure. Example process 900 is an example where the UE (e.g., UE 120) performs operations associated with QoE reporting during a network overload.

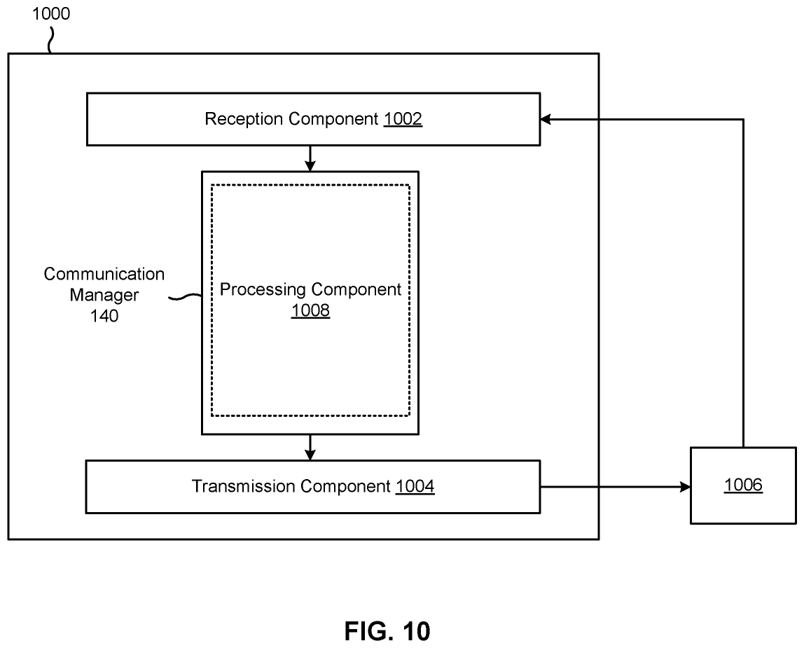

As shown in FIG. 9, in some aspects, process 900 may include determining, by a UE RRC layer of the UE, that a QoE reporting is paused based at least in part on a network overload, wherein buffered QoE data for a QoE configuration is stored at the UE when the QoE reporting is paused (block 910). For example, the UE (e.g., using communication manager 140 and/or processing component 1008, depicted in FIG. 10) may determine, by a UE RRC layer of the UE, that a QoE reporting is paused based at least in part on a network overload, wherein buffered QoE data for a QoE configuration is stored at the UE when the QoE reporting is paused, as described above.

As further shown in FIG. 9, in some aspects, process 900 may include receiving, at the UE RRC layer from a UE application layer of the UE, an attention command that indicates a QoE measurement session stop indication for the QoE configuration (block 920). For example, the UE (e.g., using communication manager 140 and/or processing component 1008, depicted in FIG. 10) may receive, at the UE RRC layer from a UE application layer of the UE, an attention command that indicates a QoE measurement session stop indication for the QoE configuration, as described above.

As further shown in FIG. 9, in some aspects, process 900 may include transmitting, based at least in part on the attention command, the buffered QoE data without discarding the buffered QoE data stored at the UE (block 930). For example, the UE (e.g., using communication manager 140 and/or transmission component 1004, depicted in FIG. 10) may transmit, based at least in part on the attention command, the buffered QoE data without discarding the buffered QoE data stored at the UE, as described above.

Process 900 may include additional aspects, such as any single aspect or any combination of aspects described below and/or in connection with one or more other processes described elsewhere herein.

In a first aspect, process 900 includes determining, by the UE RRC layer, to resume transmitting the buffered QoE data based at least in part on the attention command that indicates the QoE measurement session stop indication for the QoE configuration; transmitting, from the UE RRC layer to a network entity, a first RRC message that includes a QoE report with the buffered QoE data; and transmitting, from the UE RRC layer to the network entity, a second RRC message that includes a QoE measurement session stop indication for indicating that the buffered QoE data has been successfully transmitted to the network entity.

In a second aspect, alone or in combination with the first aspect, process 900 includes transmitting, from the UE RRC layer to a network entity and based at least in part on the attention command that indicates the QoE measurement session stop indication for the QoE configuration, a first RRC message that indicates one or more of the QoE measurement session stop indication for the QoE configuration, or a buffered QoE data indication that indicates whether the buffered QoE data is available for the QoE configuration.

In a third aspect, alone or in combination with one or more of the first and second aspects, process 900 includes receiving, at the UE RRC layer from the network entity and based at least in part on the first RRC message that indicates the QoE measurement session stop indication for the QoE configuration and no buffered QoE data indication, a second RRC message that includes a release command to release the QoE configuration.

In a fourth aspect, alone or in combination with one or more of the first through third aspects, process 900 includes receiving, at the UE RRC layer from the network entity and based at least in part on the first RRC message that indicates the QoE measurement session stop indication for the QoE configuration and the buffered QoE data indication, a second RRC message that indicates a resume command, wherein transmitting the buffered QoE data from the UE RRC layer to the network entity is resumed based at least in part on the resume command.

In a fifth aspect, alone or in combination with one or more of the first through fourth aspects, process 900 includes determining, by the UE RRC layer, to pause transmitting an RRC message that includes the QoE measurement session stop indication for the QoE configuration based at least in part on the QoE reporting being paused; and transmitting, from the UE RRC layer to a network entity, the RRC message that includes the QoE measurement session stop indication for the QoE configuration based at least in part on the QoE reporting being resumed.

In a sixth aspect, alone or in combination with one or more of the first through fifth aspects, process 900 includes receiving, at the UE RRC layer from the network entity, a configuration that configures the UE RRC layer to pause transmitting the RRC message that includes the QoE measurement session stop indication for the QoE configuration based at least in part on the QoE reporting being paused.

In a seventh aspect, alone or in combination with one or more of the first through sixth aspects, process 900 includes receiving, at the UE RRC layer from the UE application layer, multiple QoE measurement session indications for the QoE configuration during the pause for transmitting the RRC message; and overwriting, by the UE RRC layer, a previously received QoE measurement session indication of the multiple QoE measurement session indications with a newly received QoE measurement session indication of the multiple QoE measurement session indications.

In an eighth aspect, alone or in combination with one or more of the first through seventh aspects, process 900 includes transmitting, from the UE RRC layer to a network entity and based at least in part on the attention command that indicates the QoE measurement session stop indication for the QoE configuration, a first RRC message that indicates the QoE measurement session stop indication for the QoE configuration.

In a ninth aspect, alone or in combination with one or more of the first through eighth aspects, process 900 includes receiving, at the UE RRC layer from the network entity, a first RRC message that includes a release command to release the QoE configuration based at least in part on the UE moving outside of a certain area, wherein the first RRC message includes an indication to transmit the buffered QoE data for the QoE configuration; and transmitting, from the UE RRC layer to the network entity and based at least in part on the first RRC message, a second RRC message that includes a QoE report with the buffered QoE data for the QoE configuration.

In a tenth aspect, alone or in combination with one or more of the first through ninth aspects, process 900 includes transmitting, from the UE RRC layer to the network entity, an indication that all buffered QoE data for the QoE configuration for has been transmitted to the network entity, wherein the UE and the network entity release the QoE configuration based at least in part on the indication.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include a processing component 1008, among other examples.

In some aspects, the apparatus 1000 may be configured to perform one or more operations described herein in connection with FIGS. 6-8. Additionally, or alternatively, the apparatus 1000 may be configured to perform one or more processes described herein, such as process 900 of FIG. 9. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The processing component 1008 may determine that a QoE reporting is paused based at least in part on a network overload, wherein buffered QoE data for a QoE configuration is stored at the UE when the QoE reporting is paused. The processing component 1008 may receive, at the UE RRC layer from a UE application layer of the UE, an attention command that indicates a QoE measurement session stop indication for the QoE configuration. The transmission component 1004 may transmit, based at least in part on the attention command, the buffered QoE data without discarding the buffered QoE data stored at the UE.

The processing component 1008 may determine to resume transmitting the buffered QoE data based at least in part on the attention command that indicates the QoE measurement session stop indication for the QoE configuration. The transmission component 1004 may transmit, from the UE RRC layer to the network entity, a first RRC message that includes a QoE report with the buffered QoE data. The transmission component 1004 may transmit, from the UE RRC layer to a network entity, a second RRC message that includes a QoE measurement session stop indication for indicating that the buffered QoE data has been successfully transmitted to the network entity.

The transmission component 1004 may transmit, from the UE RRC layer to the network entity and based at least in part on the attention command that indicates the QoE measurement session stop indication for the QoE configuration, a first RRC message that indicates one or more of: the QoE measurement session stop indication for the QoE configuration, or a buffered QoE data indication that indicates whether the buffered QoE data is available for the QoE configuration.

The reception component 1002 may receive, at the UE RRC layer from the network entity and based at least in part on the first RRC message that indicates the QoE measurement session stop indication for the QoE configuration and no buffered QoE data indication, a second RRC message that includes a release command to release the QoE configuration. The reception component 1002 may receive, at the UE RRC layer from the network entity and based at least in part on the first RRC message that indicates the QoE measurement session stop indication for the QoE configuration and the buffered QoE data indication, a second RRC message that indicates a resume command, wherein transmitting the buffered QoE data from the UE RRC layer to the network entity is resumed based at least in part on the resume command.

The processing component 1008 may determine to pause transmitting an RRC message that includes the QoE measurement session stop indication for the QoE configuration based at least in part on the QoE reporting being paused. The transmission component 1004 may transmit, from the UE RRC layer to the network entity, the RRC message that includes the QoE measurement session stop indication for the QoE configuration based at least in part on the QoE reporting being resumed.

The reception component 1002 may receive, at the UE RRC layer from the network entity, a configuration that configures the UE RRC layer to pause transmitting the RRC message that includes the QoE measurement session stop indication for the QoE configuration based at least in part on the QoE reporting being paused. The processing component 1008 may receive, at the UE RRC layer from the UE application layer, multiple QoE measurement session indications for the QoE configuration during the pause for transmitting the RRC message. The processing component 1008 may overwrite a previously received QoE measurement session indication of the multiple QoE measurement session indications with a newly received QoE measurement session indication of the multiple QoE measurement session indications.

The transmission component 1004 may transmit, from the UE RRC layer to the network entity and based at least in part on the attention command that indicates the QoE measurement session stop indication for the QoE configuration, a first RRC message that indicates the QoE measurement session stop indication for the QoE configuration. The reception component 1002 may receive, at the UE RRC layer from the network entity, a first RRC message that includes a release command to release the QoE configuration based at least in part on the UE moving outside of a certain area, wherein the first RRC message includes an indication to transmit the buffered QoE data for the QoE configuration. The transmission component 1004 may transmit, from the UE RRC layer to the network entity and based at least in part on the first RRC message, a second RRC message that includes a QoE report with the buffered QoE data for the QoE configuration. The transmission component 1004 may transmit, from the UE RRC layer to the network entity, an indication that all buffered QoE data for the QoE configuration for has been transmitted to the network entity, wherein the UE and the network entity release the QoE configuration based at least in part on the indication.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: determining, by a UE radio resource control (RRC) layer of the UE, that a quality of experience (QoE) reporting is paused based at least in part on a network overload, wherein buffered QoE data for a QoE configuration is stored at the UE when the QoE reporting is paused; receiving, at the UE RRC layer from a UE application layer of the UE, an attention command that indicates a QoE measurement session stop indication for the QoE configuration; and transmitting, based at least in part on the attention command, the buffered QoE data without discarding the buffered QoE data stored at the UE.

Aspect 2: The method of Aspect 1, further comprising: determining, by the UE RRC layer, to resume transmitting the buffered QoE data based at least in part on the attention command that indicates the QoE measurement session stop indication for the QoE configuration; and transmitting, from the UE RRC layer to a network entity, a first RRC message that includes a QoE report with the buffered QoE data.

Aspect 3: The method of any of Aspects 1 through 2, further comprising: transmitting, from the UE RRC layer to a network entity and based at least in part on the attention command that indicates the QoE measurement session stop indication for the QoE configuration, a first RRC message that indicates one or more of: the QoE measurement session stop indication for the QoE configuration, or a buffered QoE data indication that indicates whether the buffered QoE data is available for the QoE configuration.

Aspect 4: The method of Aspect 3, further comprising: receiving, at the UE RRC layer from the network entity and based at least in part on the first RRC message that indicates the QoE measurement session stop indication for the QoE configuration and no buffered QoE data indication, a second RRC message that includes a release command to release the QoE configuration.

Aspect 5: The method of Aspect 3, further comprising: receiving, at the UE RRC layer from the network entity and based at least in part on the first RRC message that indicates the QoE measurement session stop indication for the QoE configuration and the buffered QoE data indication, a second RRC message that indicates a resume command, wherein transmitting the buffered QoE data from the UE RRC layer to the network entity is resumed based at least in part on the resume command.

Aspect 6: The method of any of Aspects 1 through 5, further comprising: determining, by the UE RRC layer, to pause transmitting an RRC message that includes the QoE measurement session stop indication for the QoE configuration based at least in part on the QoE reporting being paused; and transmitting, from the UE RRC layer to a network entity, the RRC message that includes the QoE measurement session stop indication for the QoE configuration based at least in part on the QoE reporting being resumed.

Aspect 7: The method of Aspect 6, further comprising: receiving, at the UE RRC layer from the network entity, a configuration that configures the UE RRC layer to pause transmitting the RRC message that includes the QoE measurement session stop indication for the QoE configuration based at least in part on the QoE reporting being paused.

Aspect 8: The method of Aspect 6, further comprising: receiving, at the UE RRC layer from the UE application layer, multiple QoE measurement session indications for the QoE configuration during the pause for transmitting the RRC message; and overwriting, by the UE RRC layer, a previously received QoE measurement session indication of the multiple QoE measurement session indications with a newly received QoE measurement session indication of the multiple QoE measurement session indications.

Aspect 9: The method of any of Aspects 1 through 8, further comprising: transmitting, from the UE RRC layer to a network entity and based at least in part on the attention command that indicates the QoE measurement session stop indication for the QoE configuration, a first RRC message that indicates the QoE measurement session stop indication for the QoE configuration.

Aspect 10: The method of Aspect 9, further comprising: receiving, at the UE RRC layer from the network entity, a first RRC message that includes a release command to release the QoE configuration based at least in part on the UE moving outside of a certain area, wherein the first RRC message includes an indication to transmit the buffered QoE data for the QoE configuration; and transmitting, from the UE RRC layer to the network entity and based at least in part on the first RRC message, a second RRC message that includes a QoE report with the buffered QoE data for the QoE configuration.

Aspect 11: The method of Aspect 9, further comprising: transmitting, from the UE RRC layer to the network entity, an indication that all buffered QoE data for the QoE configuration for has been transmitted to the network entity, wherein the UE and the network entity release the QoE configuration based at least in part on the indication.

Aspect 12: An apparatus for wireless communication at a device, comprising a processor; memory coupled with the processor; and instructions stored in the memory and executable by the processor to cause the apparatus to perform the method of one or more of Aspects 1-11.

Aspect 13: A device for wireless communication, comprising a memory and one or more processors coupled to the memory, the one or more processors configured to perform the method of one or more of Aspects 1-11.

Aspect 14: An apparatus for wireless communication, comprising at least one means for performing the method of one or more of Aspects 1-11.

Aspect 15: A non-transitory computer-readable medium storing code for wireless communication, the code comprising instructions executable by a processor to perform the method of one or more of Aspects 1-11.

Aspect 16: A non-transitory computer-readable medium storing a set of instructions for wireless communication, the set of instructions comprising one or more instructions that, when executed by one or more processors of a device, cause the device to perform the method of one or more of Aspects 1-11.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
determine, by a UE radio resource control (RRC) layer of the UE, that a quality of experience (QoE) reporting is paused based at least in part on a network overload, wherein buffered QoE data for a QoE configuration is stored at the UE when the QoE reporting is paused;
receive, at the UE RRC layer from a UE application layer of the UE, an attention command that indicates a QoE measurement session stop indication for the QoE configuration; and
transmit, based at least in part on the attention command, the buffered QoE data without discarding the buffered QoE data stored at the UE.

2. The apparatus of claim 1, wherein the one or more processors are further configured to:
determine, by the UE RRC layer, to resume transmitting the buffered QoE data based at least in part on the attention command that indicates the QoE measurement session stop indication for the QoE configuration; and
transmit, from the UE RRC layer to a network entity, a first RRC message that includes a QoE report with the buffered QoE data.

3. The apparatus of claim 1, wherein the one or more processors are further configured to:
transmit, from the UE RRC layer to a network entity and based at least in part on the attention command that indicates the QoE measurement session stop indication for the QoE configuration, a first RRC message that indicates one or more of: the QoE measurement session stop indication for the QoE configuration, or a buffered QoE data indication that indicates whether the buffered QoE data is available for the QoE configuration.

4. The apparatus of claim 3, wherein the one or more processors are further configured to:
receive, at the UE RRC layer from the network entity and based at least in part on the first RRC message that indicates the QoE measurement session stop indication for the QoE configuration and no buffered QoE data indication, a second RRC message that includes a release command to release the QoE configuration.

5. The apparatus of claim 3, wherein the one or more processors are further configured to:
receive, at the UE RRC layer from the network entity and based at least in part on the first RRC message that indicates the QoE measurement session stop indication for the QoE configuration and the buffered QoE data indication, a second RRC message that indicates a resume command, wherein transmitting the buffered QoE data from the UE RRC layer to the network entity is resumed based at least in part on the resume command.

6. The apparatus of claim 1, wherein the one or more processors are further configured to:
determine, by the UE RRC layer, to pause transmitting an RRC message that includes the QoE measurement session stop indication for the QoE configuration based at least in part on the QoE reporting being paused; and
transmit, from the UE RRC layer to a network entity, the RRC message that includes the QoE measurement session stop indication for the QoE configuration based at least in part on the QoE reporting being resumed.

7. The apparatus of claim 6, wherein the one or more processors are further configured to:
receive, at the UE RRC layer from the network entity, a configuration that configures the UE RRC layer to pause transmitting the RRC message that includes the QoE measurement session stop indication for the QoE configuration based at least in part on the QoE reporting being paused.

8. The apparatus of claim 6, wherein the one or more processors are further configured to:
receive, at the UE RRC layer from the UE application layer, multiple QoE measurement session indications for the QoE configuration during the pause for transmitting the RRC message; and
overwrite, by the UE RRC layer, a previously received QoE measurement session indication of the multiple QoE measurement session indications with a newly received QoE measurement session indication of the multiple QoE measurement session indications.

9. The apparatus of claim 1, wherein the one or more processors are further configured to:
transmit, from the UE RRC layer to a network entity and based at least in part on the attention command that indicates the QoE measurement session stop indication for the QoE configuration, a first RRC message that indicates the QoE measurement session stop indication for the QoE configuration.

10. The apparatus of claim 9, wherein the one or more processors are further configured to:
receive, at the UE RRC layer from the network entity, a first RRC message that includes a release command to release the QoE configuration based at least in part on the UE moving outside of a certain area, wherein the first RRC message includes an indication to transmit the buffered QoE data for the QoE configuration; and
transmit, from the UE RRC layer to the network entity and based at least in part on the first RRC message, a second RRC message that includes a QoE report with the buffered QoE data for the QoE configuration.

11. The apparatus of claim 9, wherein the one or more processors are further configured to:
transmit, from the UE RRC layer to the network entity, an indication that all buffered QoE data for the QoE configuration for has been transmitted to the network entity, wherein the UE and the network entity release the QoE configuration based at least in part on the indication.

12. A method of wireless communication performed by a user equipment (UE), comprising:
determining, by a UE radio resource control (RRC) layer of the UE, that a quality of experience (QoE) reporting is paused based at least in part on a network overload, wherein buffered QoE data for a QoE configuration is stored at the UE when the QoE reporting is paused;
receiving, at the UE RRC layer from a UE application layer of the UE, an attention command that indicates a QoE measurement session stop indication for the QoE configuration; and
transmitting, based at least in part on the attention command, the buffered QoE data without discarding the buffered QoE data stored at the UE.

13. The method of claim 12, further comprising:
determining, by the UE RRC layer, to resume transmitting the buffered QoE data based at least in part on the attention command that indicates the QoE measurement session stop indication for the QoE configuration; and
transmitting, from the UE RRC layer to a network entity, a first RRC message that includes a QoE report with the buffered QoE data.

14. The method of claim 12, further comprising:
transmitting, from the UE RRC layer to a network entity and based at least in part on the attention command that indicates the QoE measurement session stop indication for the QoE configuration, a first RRC message that indicates one or more of: the QoE measurement session stop indication for the QoE configuration, or a buffered QoE data indication that indicates whether the buffered QoE data is available for the QoE configuration.

15. The method of claim 14, further comprising:
receiving, at the UE RRC layer from the network entity and based at least in part on the first RRC message that indicates the QoE measurement session stop indication for the QoE configuration and no buffered QoE data indication, a second RRC message that includes a release command to release the QoE configuration.

16. The method of claim 14, further comprising:
receiving, at the UE RRC layer from the network entity and based at least in part on the first RRC message that indicates the QoE measurement session stop indication for the QoE configuration and the buffered QoE data indication, a second RRC message that indicates a resume command, wherein transmitting the buffered QoE data from the UE RRC layer to the network entity is resumed based at least in part on the resume command.

17. The method of claim 12, further comprising:
determining, by the UE RRC layer, to pause transmitting an RRC message that includes the QoE measurement session stop indication for the QoE configuration based at least in part on the QoE reporting being paused; and
transmitting, from the UE RRC layer to a network entity, the RRC message that includes the QoE measurement session stop indication for the QoE configuration based at least in part on the QoE reporting being resumed.

18. The method of claim 17, further comprising:
receiving, at the UE RRC layer from the network entity, a configuration that configures the UE RRC layer to pause transmitting the RRC message that includes the QoE measurement session stop indication for the QoE configuration based at least in part on the QoE reporting being paused.

19. The method of claim 17, further comprising:
receiving, at the UE RRC layer from the UE application layer, multiple QoE measurement session indications for the QoE configuration during the pause for transmitting the RRC message; and
overwriting, by the UE RRC layer, a previously received QoE measurement session indication of the multiple QoE measurement session indications with a newly received QoE measurement session indication of the multiple QoE measurement session indications.

20. The method of claim 12, further comprising:
transmitting, from the UE RRC layer to a network entity and based at least in part on the attention command that indicates the QoE measurement session stop indication for the QoE configuration, a first RRC message that indicates the QoE measurement session stop indication for the QoE configuration. 21 The method of claim 20, further comprising:
receiving, at the UE RRC layer from the network entity, a first RRC message that includes a release command to release the QoE configuration based at least in part on the UE moving outside of a certain area, wherein the first RRC message includes an indication to transmit the buffered QoE data for the QoE configuration; and
transmitting, from the UE RRC layer to the network entity and based at least in part on the first RRC message, a second RRC message that includes a QoE report with the buffered QoE data for the QoE configuration.

22. The method of claim 20, further comprising:
transmitting, from the UE RRC layer to the network entity, an indication that all buffered QoE data for the QoE configuration for has been transmitted to the network entity, wherein the UE and the network entity release the QoE configuration based at least in part on the indication.

23. A non-transitory computer-readable medium storing a set of instructions for wireless communication, the set of instructions comprising:
one or more instructions that, when executed by one or more processors of a user equipment (UE), cause the UE to:
determine, by a UE radio resource control (RRC) layer of the UE, that a quality of experience (QoE) reporting is paused based at least in part on a network overload, wherein buffered QoE data for a QoE configuration is stored at the UE when the QoE reporting is paused;
receive, at the UE RRC layer from a UE application layer of the UE, an attention command that indicates a QoE measurement session stop indication for the QoE configuration; and
transmit, based at least in part on the attention command, the buffered QoE data without discarding the buffered QoE data stored at the UE.

24. The non-transitory computer-readable medium of claim 23, wherein the one or more instructions further cause the UE to:
determine, by the UE RRC layer, to resume transmitting the buffered QoE data based at least in part on the attention command that indicates the QoE measurement session stop indication for the QoE configuration; and
transmit, from the UE RRC layer to a network entity, a first RRC message that includes a QoE report with the buffered QoE data.

25. The non-transitory computer-readable medium of claim 23, wherein the one or more instructions further cause the UE to:
transmit, from the UE RRC layer to a network entity and based at least in part on the attention command that indicates the QoE measurement session stop indication for the QoE configuration, a first RRC message that indicates one or more of: the QoE measurement session stop indication for the QoE configuration, or a buffered QoE data indication that indicates whether the buffered QoE data is available for the QoE configuration.

26. The non-transitory computer-readable medium of claim 23, wherein the one or more instructions further cause the UE layer to:
determine, by the UE RRC layer, to pause transmitting an RRC message that includes the QoE measurement session stop indication for the QoE configuration based at least in part on the QoE reporting being paused; and
determine, from the UE RRC layer to a network entity, the RRC message that includes the QoE measurement session stop indication for the QoE configuration based at least in part on the QoE reporting being resumed.

27. An apparatus for wireless communication, comprising:
means for determining, by an apparatus radio resource control (RRC) layer of the apparatus, that a quality of experience (QoE) reporting is paused based at least in part on a network overload, wherein buffered QoE data for a QoE configuration is stored at the apparatus when the QoE reporting is paused;
means for receiving, at the apparatus RRC layer from an apparatus application layer of the apparatus, an attention command that indicates a QoE measurement session stop indication for the QoE configuration; and
means for transmitting, based at least in part on the attention command, the buffered QoE data without discarding the buffered QoE data stored at the apparatus.

28. The apparatus of claim 27, further comprising:
means for determining, by the apparatus RRC layer, to resume transmitting the buffered QoE data based at least in part on the attention command that indicates the QoE measurement session stop indication for the QoE configuration; and
means for transmitting, from the apparatus RRC layer to a network entity, a first RRC message that includes a QoE report with the buffered QoE data.

29. The apparatus of claim 27, further comprising:
means for transmitting, from the apparatus RRC layer to a network entity and based at least in part on the attention command that indicates the QoE measurement session stop indication for the QoE configuration, a first RRC message that indicates one or more of: the QoE measurement session stop indication for the QoE configuration, or a buffered QoE data indication that indicates whether the buffered QoE data is available for the QoE configuration.

30. The apparatus of claim 27, further comprising:
means for determining, by the apparatus RRC layer, to pause transmitting an RRC message that includes the QoE measurement session stop indication for the QoE configuration based at least in part on the QoE reporting being paused; and
means for transmitting, from the apparatus RRC layer to a network entity, the RRC message that includes the QoE measurement session stop indication for the QoE configuration based at least in part on the QoE reporting being resumed.
